(19) United States
(12) Patent Application Publication
(10) Pub. No.: US 2014/0149080 A1
(43) Pub. Date: May 29, 2014

(54) SENSING DEVICE HAVING MULTIPLE SENSING UNITS, SENSING METHOD, AND RECORDING MEDIUM THEREOF

(71) Applicant: INSTITUTE FOR INFORMATION INDUSTRY, Taipei City (TW)

(72) Inventors: Chin-Shun HSU, Kaohsiung City (TW); Po-Cheng HUANG, Yunlin County (TW); Ming-Cheng LIN, Kaohsiung City (TW)

(73) Assignee: INSTITUTE FOR INFORMATION INDUSTRY, Taipei City (TW)

(21) Appl. No.: 13/714,197

(22) Filed: Dec. 13, 2012

(30) Foreign Application Priority Data
Nov. 27, 2012 (TW) 101144337

(51) Int. Cl. G06F 17/00

(52) U.S. Cl. CPC G06F 17/00
USPC 702/188

(57) ABSTRACT

A sensing device having multiple sensing units, a sensing method, and a recording medium thereof are provided. A system includes a plurality of sensing units, an operational module, a selection module, and a sampling module. The selection module is connected to a target sensing unit according to a selection signal provided by the operational module, and obtains a sensing signal provided by the target sensing unit. The sampling module obtains the sensing signal from the selection module.

### CROSS-REFERENCE TO RELATED APPLICATION

This application claims the benefit of Taiwan Patent Application No. 101144337, filed on Nov. 27, 2012, which is hereby incorporated by reference for all purposes as if fully set forth herein.

### BACKGROUND OF THE INVENTION

1. Field of Invention

The present invention relates to a sensing device, a sensing method, and a recording medium thereof, and more particularly to a sensing device, a sensing method, and a recording medium thereof for multiple sensing units to perform a sensing operation.

2. Related Art

In the prior art, an environmental sensing device used for cultivating plants is usually an integrated sensing device, that is, a control module, a sampling module, and a sensing unit are designed in an integral. Therefore, more than one sensing device is required to detect an environment for growth of a cultivated plant, such as a temperature, humidity, and illumination. In order to perform environmental detection on a large number of plants, a large number of sensing devices have to be provided and configured. For sensing devices on the current market, each sensing device is required to be controlled by a microprocessor or a control unit, thereby greatly increasing hardware costs.

### SUMMARY OF THE INVENTION

An objective of the present invention is to provide a sensing device having multiple sensing units, a sensing method, and a recording medium which facilitate selection of sensing units, so as enable multiple sensing units to perform sensing and provide signals.

A sensing device provided by the present invention comprises a plurality of sensing units, an operational module, a selection module, and a sampling module. The selection module is used to connect to the operational module, each of the sensing units, and the sampling module.

The operational module generates a selection signal. The selection module connects to a target sensing unit among all the sensing units according to the selection signal, so as to obtain a sensing signal of the target sensing unit. The sampling module obtains the sensing signal from the selection module.

A sensing method provided by the present invention is applicable to a sensing device having multiple sensing units. The method comprises: an operational module sending a selection signal; a selection module connecting to a target sensing unit among a plurality of sensing units according to the selection signal, so as to obtain a sensing signal provided by the target sensing unit; and a sampling module obtaining the sensing signal transmitted by the selection module.

The present invention also provides a recording medium, which stores program codes capable of being read by an electronic device. The electronic device is connected to a plurality of sensing units. When the electronic device reads the program codes, a sensing method is executed. The method is as what is described above.

The sensing device provided by the present invention may be provided with multiple sensing units. The selection module performs selection on the sensing units, so as to process sensing signals provided by the sensing units one by one. Therefore, with the number of control components being small, multiple sensing units are controlled, the number of the sensing units may be disposed accordingly according to needs of a user, implementation costs of the sensing device can be effectively lowered, and applicability of the sensing device is improved. Further, the present invention is applicable to a conventional architecture of a sensing device without dramatically changing a hardware architecture, and can reduce hardware configuration costs and improve applicability of the sensing device.

In order to make the aforementioned features and advantages of the present invention more comprehensible, embodiments accompanied with figures are described in detail below.

### BRIEF DESCRIPTION OF THE DRAWINGS

The present invention will become more fully understood from the detailed description given herein below for illustration only, and thus are not limitative of the present invention, and wherein:

FIG. 1 is a schematic structural view of a sensing device according to a first embodiment of the present invention;

FIG. 2 is a schematic structural view of a sensing device according to a second embodiment of the present invention;

FIG. 3 is a schematic structural view of a sensing device according to a third embodiment of the present invention;

FIG. 4 is a schematic structural view of a sensing device according to a fourth embodiment of the present invention; and

FIG. 5 is a schematic flow chart of a sensing method according to a first embodiment of the present invention.

### DETAILED DESCRIPTION OF THE INVENTION

Preferred embodiments of the present invention are illustrated below in detail with reference to the accompanying drawings.

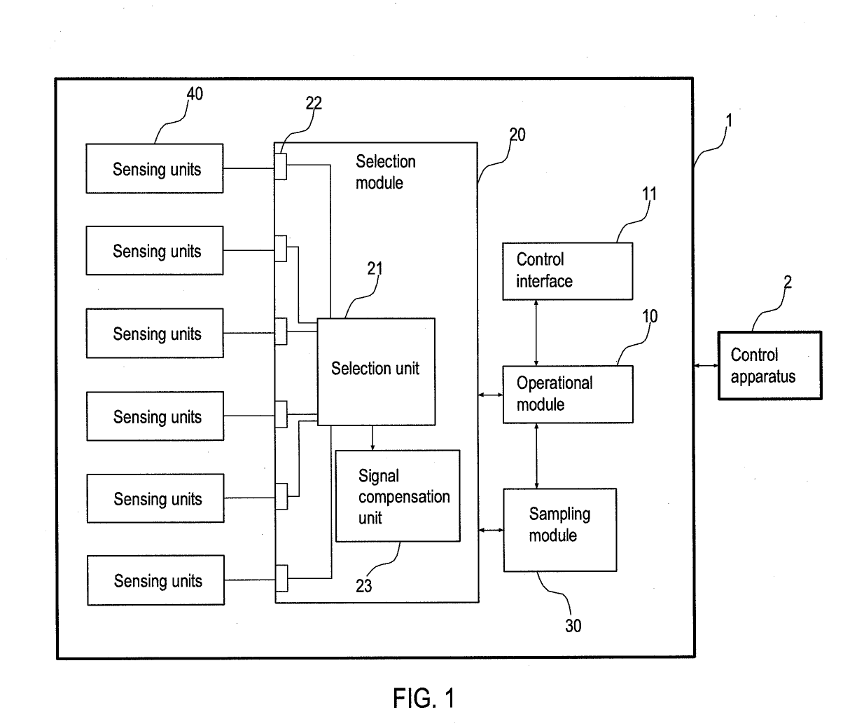

FIG. 1 is a schematic structural view of a sensing device according to a first embodiment of the present invention. A sensing device 1 includes a plurality of sensing units 40, an operational module 10, a selection module 20, and a sampling module 30.

The operational module 10 is used to generate a selection signal. The operational module 10 may be a processor or any control circuit, device, apparatus, chip, and integrated circuit capable of sending data. The operational module 10 may send the selection signal spontaneously according to internally stored settings. Alternatively, a setting instruction is sent through a control interface 11 of the sensing device or a control apparatus 2 connected to the sensing device 1, so as to send the selection signal according to the setting instruction.

In some embodiments, the selection module 20 may be a selection matrix circuit, device, or circuit including at least one of a multiplexer, a relay, a diode, a transistor, and a related integrated circuit, and has capability of being connected to multiple components, so as to be connected to the plurality of sensing units and the operational module. Upon obtaining the selection signal, the selection module 20 is connected to one target sensing unit among all the sensing units 40 according to the selection signal, so as to obtain a sensing signal of the target sensing unit.

Taking FIG. 1 for example, the selection module 20 includes at least one selection unit 21 and a plurality of connection ports 22. A sensing unit 40 is connected to one of the connection ports 22. The selection module 20 is connected to the target sensing unit according to the selection signal. The selection unit 21 selects, according to the selection signal, a target connection port connected to the target sensing unit, so as to obtain the sensing signal from the target sensing unit connected to the target connection port. In this embodiment, each sensing unit 40 may correspond to a connection port 22 respectively. The selection module 20 may select any one of the multiple sensing units 40 as the target sensing unit, and a connection port corresponding to the target sensing unit becomes the target connection port. After obtaining the sensing signal from the target sensing unit, the selection module 20 may select again other sensing unit 40 among the multiple sensing units 40 as a target sensing unit, and another connection port 22 corresponding to the newly selected target sensing unit becomes a target connection port.

The sampling module 30 is used to sample the sensing signal, so as to transmit the sampled signal to the operational module 10 that performs a subsequent operation. Alternatively, the sensing device may transmit, by any data transmission means, the sampled signal to the control apparatus connected to the sensing device.

Further, the selection module 20 further includes a signal compensation unit 23. After receiving the sensing signal, the signal compensation unit 23 may adjust the sensing signal, for example, amplify the signal, or perform rectification and filtering. The selection module 20 transmits the adjusted sensing signal to the sampling module 30. The signal compensation unit 23 is a combination including at least one of a voltage stabilizer unit, a rectifier unit, a filter unit, a comparator unit, and a signal amplifier unit.

Further, the operational module 10 may continuously generate multiple selection signals according to a selection order, and time intervals between the generated selection signals are the same, different, partially the same, or partially different. That is to say, the operational module 10 may generate multiple selection signals in order at fixed time, or generate multiple selection signals by setting required time periods. Therefore, no fixed time intervals lie between the selection signals. The selection module 20 is connected to corresponding target sensing units one by one according to the selection signals, so as to obtain corresponding sensing signals from the target sensing units respectively. The sampling module 30 obtains also according to the selection signals the corresponding sensing signals from the selection module 20 in the same order. However, the selection order may be determined according to a forward order, a backward order, or random numbers of the multiple sensing units 40, or other selection means (for example, a sensing time period of each sensing unit 40 is set, and the selection order is generated according to the time periods) are applicable, and the present invention is not limited thereto.

In some embodiments, in order to accurately obtain sensing signals corresponding to the multiple target sensing units, the operational module 10 may further generate a sampling signal according to the selection signal. The sampling module 30 can be connected to the selection module 20 according to the sampling signal, so as to obtain required sensing signals. Specifically, after sending a selection signal and waiting for a required work required time, the operational module 10 generates a sampling signal sent to the sampling module 30. The work required time is a required time for a target sensing unit to operate and generate a sensing signal. Upon obtaining the sampling signal, the sampling module 30 is connected to the selection module 20 to obtain a sensing signal.

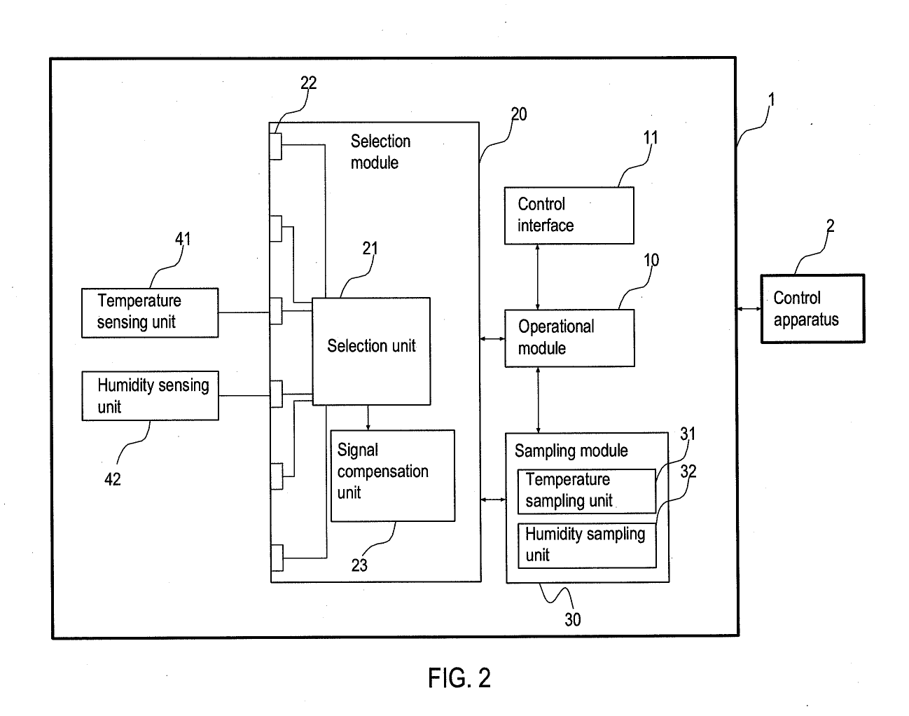

FIG. 2 is a schematic structural view of a sensing device according to a second embodiment of the present invention. The differences between the above embodiment and this embodiment are that the sensing units may be classified into a plurality of types and the sampling module 30 also includes multiple types of sampling units. The sensing units may be, for example, a temperature sensing unit, a humidity sensing unit, an illumination sensing unit, . . . , or any other sensing type. In this embodiment, each sensing unit belongs to one of the plurality of classified types. Types of the sampling units correspond to the types of the sensing units.

When providing a selection signal, the operational module 10 further generate a sampling signal corresponding to the selection signal for the sampling module 30, so as to set the sampling module 30 to select a target sampling unit corresponding to the type of a target sensing unit. That is to say, when generating a selection signal, the operational module 10 may determine the type of a corresponding sampling unit according to the type of a target sensing unit in the selection signal. Then, the sampling module 30 may select a target sampling unit according to the type of the sampling unit, and the target sampling unit obtains a sensing signal.

As shown in FIG. 2, an example is taken, which includes two sensing units and two sampling units. A type of a temperature sensing unit 41 corresponds to a type of a temperature sampling unit 31, and a type of a humidity sensing unit 42 corresponds to a type of a humidity sampling unit 32.

The operational module 10 generates a selection signal to designate the temperature sensing unit 41, so that the temperature sensing unit 41 is a target sensing unit. Meanwhile, the operational module 10 generates a sampling signal to designate the temperature sampling unit 31. The selection module 20 is connected to the temperature sensing unit 41 to obtain a temperature sensing signal, so as to transmit the temperature sensing signal to the sampling module 30. The temperature sensing signal is received by the temperature sampling unit 31.

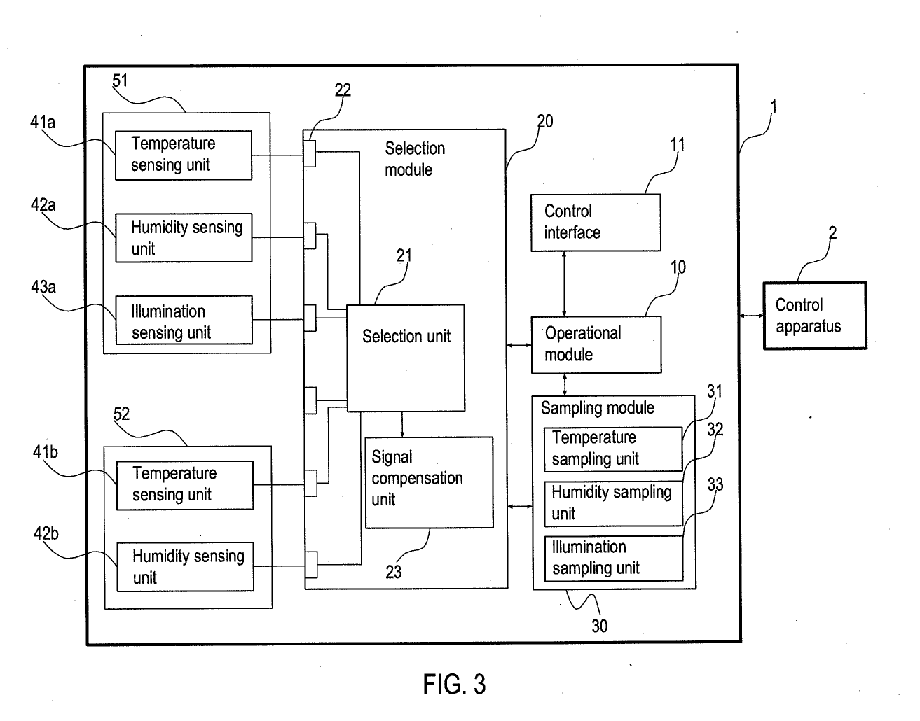

FIG. 3 is a schematic structural view of a sensing device according to a third embodiment of the present invention, and FIG. 1 and FIG. 2 may be referred to for better understanding. Different from the above embodiments, in this embodiment, in addition to that the sensing units 40 include a plurality of types, the sensing units 40 are further grouped into multiple sensing groups (for example, sensing groups 51 and 52 shown in FIG. 3). Each sensing group includes multiple types of sensing units 40. However, the number and types of the sensing units 40 in the sensing group may be determined according to needs of a designer or a user, and the present invention is not limited thereto.

For a target sensing group among all sensing groups, the operational module 10 may send a selection signal to the selection module 20 according to each sensing unit 40 in the target sensing group. Meanwhile, the operational module 10 sends a sampling signal according to the sent selection signal or according to a type of each sensing unit 40 in the target sensing group. That is to say, the operational module 10 may select a target sensing group, then sends a selection signal to all sensing units in the target sensing group one by one, and then generates a corresponding sampling signal according to each selection signal and a work required time that is required. In this way, sensing units 40 in a group may perform sensing at the same time or approximately the same time.

After multiple selection signals are generated for a target sensing group, the selection module 20 is connected to one of the sensing units in the target sensing group according to each selection signal, so as to obtain sensing signals of the sensing units. Correspondingly, the sampling module 30 enables the corresponding sampling unit according to each sampling signal to obtain a corresponding sensing signal. In some specific embodiments, the operational module 10 may select only one target sensing unit from a target sensing group to perform sensing, and set the sampling module 30 to select a target sampling unit corresponding to a type of the target sensing unit, so that the target sampling unit obtains a sensing signal provided by the target sensing unit.

As shown in FIG. 3, it is assumed that a first sensing group 51 includes a temperature sensing unit 41a, a humidity sensing unit 42a, and an illumination sensing unit 43a. A second sensing group 52 includes a temperature sensing unit 41b and a humidity sensing unit 42b. The operational module 10 sends a selection signal for designating the first sensing group 51, so as to make the selection module 20 be connected to the temperature sensing unit 41a, the humidity sensing unit 42a, and the illumination sensing unit 43a of the first sensing group 51. The selection module 20 obtains a temperature sensing signal of the temperature sensing unit 41a, a humidity sensing signal of the humidity sensing unit 42a, and an illumination sensing signal of the illumination sensing unit 43a respectively.

The operational module 10 sends a sampling signal to make the sampling module 30 use a temperature sampling unit 31, a humidity sampling unit 32, and an illumination sampling unit 33 corresponding to the first sensing group 51. The temperature sampling unit 31 obtains the temperature sensing signal, the humidity sampling unit 32 obtains the humidity sensing signal, and the illumination sampling unit 33 obtains the illumination sensing signal.

Similarly, the operational module 10 sends a selection signal for designating the second sensing group 52, so as to make the selection module 20 be connected to the temperature sensing unit 41b and the humidity sensing unit 42b of the second sensing group 52, so as to obtain a temperature sensing signal of the temperature sensing unit 41b and a humidity sensing signal of the humidity sensing unit 42b respectively. The operational module 10 also sends a sampling signal to make the sampling module 30 use the temperature sampling unit 31 and the humidity sampling unit 32 corresponding to the second sensing group 52.

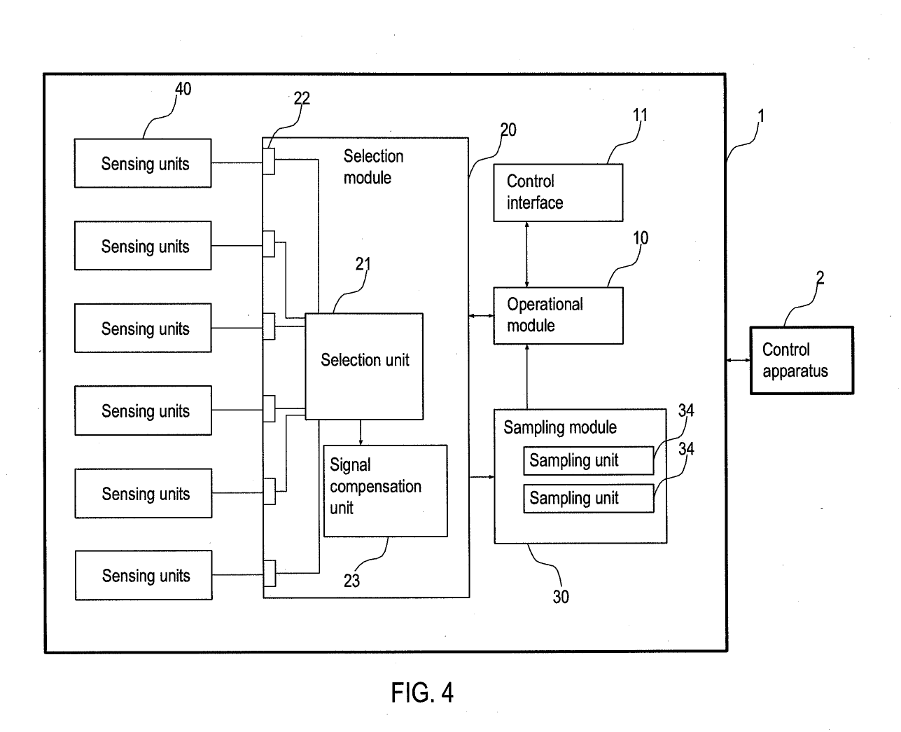

FIG. 4 is a schematic structural view of a sensing device according to a fourth embodiment of the present invention. The differences between the above embodiments and this embodiment are that, the sampling module 30 is only unidirectionally connected to the operational module 10, and the sampling module 30 includes a plurality types of sampling units 34. A selection signal corresponds to a target sensing unit and a target sampling unit, and the target sensing unit corresponds to a type of the target sampling unit. The selection module 20 is connected to the target sensing unit according to the selection signal, and transmits a sensing signal provided by the target sensing unit to the target sampling unit. In this embodiment, at the time of generating the selection signal, the operational module 10 already includes relevant data of the target sensing unit and the target sampling unit. After obtaining the sensing signal of the target sensing unit according to the selection signal, the selection module 20 may transmit the sensing signal to the target sampling unit according to the relevant data of the target sampling unit.

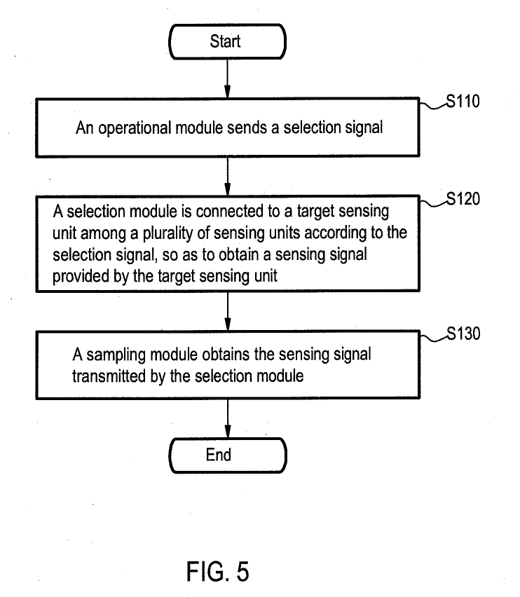

FIG. 5 is a schematic flow chart of a sensing method according to a first embodiment of the present invention, which is applicable to a sensing device having multiple sensing units. Refer to FIG. 1 to FIG. 4 for better understanding. The method is illustrated below.

An operational module sends a selection signal (Step S110). In this step, different architectures of a sensing device result in different implementation manners.

As shown in FIG. 1, a sensing device 1 has multiple sensing units 40, but has one sampling module 30. An operational module 10 may send the selection signal spontaneously according to internally stored settings. Alternatively, a setting instruction is sent through a control interface 11 of the sensing device 1 or a control apparatus 2 connected to the sensing device 1, so as to send the selection signal according to the setting instruction. A selection order and time intervals according to which the operational module 10 sends the selection signal may be set by a designer or set according to needs of a user.

Further, the operational module 10 may send a sampling signal after waiting for a work required time following the sending of the selection signal. The work required time is a required time for the target sensing unit to operate and generate a sensing signal in a subsequent step.

As shown in FIG. 2, the sensing device has multiple sensing units (for example, 41 and 42), and has multiple sampling units (for example, 31 and 32). When a selection signal is generated, the operational module 10 generates a sampling signal corresponding to the selection signal for the sampling module 30, so as to set the sampling module 30 to select a target sampling unit corresponding to a type of a target sensing unit.

As shown in FIG. 3, for a target sensing group among all sensing groups (for example, 51 and 52), the operational module 10 may send a selection signal to the selection module 20 according to each sensing unit in the target sensing group. Meanwhile, the operational module 10 sends a sampling signal according to the sent selection signal or according to a type of each sensing unit in the target sensing group.

As shown in FIG. 4, the operational module 10 sends only one selection signal to the selection module 20. A selection signal corresponds to a target sensing unit and a target sampling unit, and the target sensing unit corresponds to a type of the target sampling unit.

Then, a selection module is connected to a target sensing unit among a plurality of sensing units according to the selection signal, so as to obtain a sensing signal provided by the target sensing unit (Step S120). In this step, different architectures of the sensing device result in different implementation manners.

As shown in FIG. 1 and FIG. 2, upon obtaining the selection signal, the selection module 20 is connected to one target sensing unit among all the sensing units 40 according to the selection signal, so as to obtain a sensing signal of the target sensing unit. Alternatively, when the operational module 10 sends multiple selection signals, the selection module 20 is connected to corresponding target sensing units one by one according to the selection signals or even time at which the selection signal are obtained, so as to obtain corresponding sensing signals from the target sensing units respectively.

As shown in FIG. 3, the selection module 20 is connected to a sensing unit of a target sensing group according to each selection signal. Taking a second sensing group 52 for example, the selection module is connected to a temperature sensing unit 41b and a humidity sensing unit 42b respectively, so as to obtain sensing signals of the sensing units. Alternatively, the operational module 10 sets the selection module 20 to select one of the target sensing units in the target sensing group to obtain a sensing signal of the target sensing unit, for example, select the humidity sensing unit 42b from the second sensing group 52 as the target sensing unit.

As shown in FIG. 4, according to a selection signal sent by the operational module 10, the selection module 20 selects and is connected to a target sensing unit among all the sensing units 40, and transmits a sensing signal provided by the target sensing unit to the sampling module 30.

However, whatever an architecture of the sensing device is, the selection module 20 is provided with a signal compensation unit 23. After receiving a sensing signal, the signal compensation unit 23 adjusts the sensing signal. The selection module 20 transmits the adjusted sensing signal to the sampling module 30.

Then, a sampling module obtains the sensing signal transmitted by the selection module (Step S130). In this step, different architectures of the sensing device result in different implementation manners.

As shown in FIG. 1, the sampling module 30 is used to sample the sensing signal, so as to transmit the sampled signal to the operational module 10 that performs a subsequent operation. Alternatively, the sensing device 1 transmits the sampled signal to a control apparatus 2 by any data transmission means. However, when the operational module 10 sends multiple selection signals, the sampling module 30 obtains corresponding sensing signals from the selection module 20 in a same order according to the selection signals. Alternatively, the sampling module 30 waits for a sampling signal additionally sent by the operational module 10, and only starts obtaining sensing signals from the selection module 20 upon obtaining the sampling signal.

As shown in FIG. 2, the operational module 10 provides the sampling module 30 with a sampling signal, so as to set the sampling module 30 to select a target sampling unit corresponding to a type of a target sensing unit. For example, when the target sensing unit is a humidity sensing unit 42, the target sampling unit is a humidity sampling unit 32. The humidity sampling unit 32 obtains a humidity sensing signal provided by the humidity sensing unit 42 from the selection module 20.

As shown in FIG. 3, the sampling module 30 uses a corresponding sampling unit according to the sampling signal, so as to enable the sampling unit to obtain a corresponding sensing signal. For example, when the selection module is connected to the first sensing group, the sampling module 30 enables a temperature sampling unit 31, a humidity sampling unit 32, and an illumination sampling unit 33. Alternatively, when the operational module 10 selects a target sensing unit from a target sensing group, the operational module 10 sets the sampling module 30 to select a target sampling unit corresponding to a type of the target sensing unit, so that the target sampling unit obtains a sensing signal provided by the target sensing unit.

As shown in FIG. 4, the selection module 20 is connected to a target sensing unit among all the sensing units 40 according to a selection signal, and sets the sampling module to enable a target sampling unit among all sampling units 34, so as to transmit a sensing signal provided by the target sensing unit to the target sampling unit. The target sensing unit corresponds to a type of the target sampling unit.

A recording medium provided by the present invention stores program codes capable of being read by an electronic device. The electronic device is connected to a plurality of sensing units. When the electronic device reads the program codes, a multi-sensing method is executed. The method is described above, and description is not repeated herein.

In view of the above, implementation or embodiments of the technical solutions presented by the present invention to solve problems are described herein, which is not intended to limit the scope of implementation of the present invention. Equivalent modification and improvement in accordance with the claims of the present invention or made according to the claims of the present invention is covered by the claims of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A sensing device having multiple sensing units, comprising:
a plurality of sensing units;
an operational module, used to generate a selection signal;
a selection module, used to connect to the operational module and the sensing units, receive the selection signal, and connected to a target sensing unit among the sensing units according to the selection signal, so as to obtain a sensing signal of the target sensing unit; and
a sampling module, used to connect to the selection module to obtain the sensing signal.

2. The sensing device having multiple sensing units according to claim 1, wherein the sensing units are classified into a plurality of types, each sensing unit corresponds to one of the types; the sampling module is further used to connect to the operational module and has a plurality types of sampling units, each type of the sampling unit corresponds to one of the types; and the operational module is further used to generate a corresponding sampling signal when the selection signal is generated, to set the sampling module to select a target sampling unit corresponding to a type of the target sensing unit, and the target sampling unit obtains the sensing signal.

3. The sensing device having multiple sensing units according to claim 1, wherein the sensing units are classified into a plurality of types, each sensing unit corresponds to one of the types; and the sensing units are grouped into a plurality of sensing groups, and each sensing group comprises a plurality of types of sensing units.

4. The sensing device having multiple sensing units according to claim 3, wherein the operational module is further used to generate a corresponding selection signal for each sensing unit in a target sensing group among the plurality of sensing groups respectively, and generate corresponding sampling signals; the selection module obtains a sensing signal of each sensing unit from the sensing units in the target sensing group respectively according to the selection signals; and the sampling module respectively obtains the sensing signal of each sensing unit in the target sensing group respectively according to the corresponding sampling signals.

5. The sensing device having multiple sensing units according to claim 4, wherein the sampling module is further used to connect to the operational module, and has a plurality types of sampling units, and each type of the sampling unit corresponds to one of the types; and when the operational module generates a corresponding sampling signal for each sensing unit in the target sensing group respectively, the operational module sets the sampling module to select a corresponding target sampling unit corresponding to the type of each target sensing unit in the target sensing group, and the target sampling unit obtains the sensing signal.

6. The sensing device having multiple sensing units according to claim 1, wherein the sampling module comprises a plurality types of sampling units; the selection signal corresponds to the target sensing unit among the sensing units and a target sampling unit among the sampling units; and the selection module connects to the target sensing unit according to the selection signal, so as to obtain a sensing signal of the target sensing unit, and transmit the sensing signal to the target sampling unit.

7. The sensing device having multiple sensing units according to claim 1, wherein the operational module continuously generate a plurality of selection signals according to a selection order; the selection module connects to corresponding target sensing units in order according to the plurality of selection signals, to obtain corresponding sensing signals; and the sampling module obtains corresponding sensing signals from the selection module in order according to the plurality of selection signals.

8. The sensing device having multiple sensing units according to claim 1, wherein the selection module comprises at least one selection unit and a plurality of connection ports; each sensing unit connects to one of the connection ports; and the selection module connects to the target sensing unit according to the selection signal, which comprises: the selection unit selecting a target connection port connected to the target sensing unit according to the selection signal, so as to obtain the sensing signal from the target sensing unit connected to the target connection port.

9. The sensing device having multiple sensing units according to claim 1, wherein the operational module is further used to generate a sampling signal, and the sampling module connects to the selection module according to the sampling signal, so as to obtain the sensing signal.

10. A sensing method, applicable to a sensing device having multiple sensing units, the method comprising:
sending a selection signal by an operational module;
connecting to a target sensing unit among a plurality of sensing units according to the selection signal by a selection module, so as to obtain a sensing signal provided by the target sensing unit; and
obtaining the sensing signal transmitted by the selection module by a sampling module.

11. The sensing method according to claim 10, wherein the sensing units are grouped into a plurality of sensing groups, each sensing group comprises a plurality types of sensing units, and the step of connecting to a target sensing unit among the plurality of sensing units according to the selection signal by the selection module comprises:
selecting a target sensing unit from the plurality of sensing units comprised by the target sensing group according to the selection signal by the selection module, so as to obtain the sensing signal provided by the target sensing unit.

12. The sensing method according to claim 10, wherein types of the sensing units are different, the sampling module has a plurality of sampling units, and the step of obtaining the sensing signal transmitted by the selection module by the sampling module comprises:
setting the sampling module to select a target sampling unit corresponding to the type of the target sensing unit by the operational module; and
obtaining the sensing signal by the target sampling unit.

13. The sensing method according to claim 10, wherein in the step of sending the selection signal by the operational module, the operational module continuously sends the selection signal according to a selection order, and in the step of obtaining the sensing signal transmitted by the selection module by the sampling module, the sampling module obtains corresponding sensing signals from the selection module in order according to the plurality of selection signals.

14. The sensing method according to claim 10, wherein after the step of the operational module sending the selection signal, the method further comprises:
waiting for a work required time corresponding to operation of the target sensing unit by the operational module;
sending a sampling signal to the sampling module by the operational module; and
when the sampling module obtains the sampling signal, performing the step of obtaining the sensing signal transmitted by the selection module by the sampling module.

15. A non-transitory recording medium, storing program codes capable of being read by an electronic device, the electronic device being connected to a plurality of sensing units, and when the electronic device reads the program codes, executing a multi-sensing method, the method comprising the following steps:
sending a selection signal by an operational module;
connecting to a target sensing unit among a plurality of sensing units according to the selection signal by a selection module, so as to obtain a sensing signal provided by the target sensing unit; and
obtaining the sensing signal transmitted by the selection module by a sampling module.
